(19) United States
(12) Patent Application Publication
(10) Pub. No.: US 2003/0188157 A1
(43) Pub. Date: Oct. 2, 2003

(54) License manager

(76) Inventors: Johannes Birzer, Stulin (DE); Martin Kiesel, Poxdorf (DE); Andreas Hartinger, Erlangen (DE)

Correspondence Address: HENRY M FEIEREISEN, LLC, 350 FIFTH AVENUE, SUITE 4714, NEW YORK, NY, 10118, US

(21) Appl. No.: 10/276,604

(22) PCT Filed: Apr. 30, 2001
(86) PCT No.: PCT/DE01/01634

(30) Foreign Application Priority Data
May 18, 2000 (DE) 100 23 818.1

(51) Int. Cl. H04L 9/00

(52) U.S. Cl. 713/161

(57) ABSTRACT

The invention relates to a method for granting licenses and authorising access to software components or instantiations of software objects through the purchase of value points (WP, WP1-WPn), whereby a specific number of value points is allocated to each software module or to each instantiation of a module. Granting licenses is based on a comparison between the acquired value points (WP, WP1-WPn) (credit) and the value points required for an application (WP, WP1-WPn) (debit). The comparison is carried out by a license manager which is advantageously implemented as a mobile agent in distributed environments.

The invention relates to a method for licensing and/or access authorization of software modules for industrial controllers and/or computer systems.

It is customary to explicitly associate licensing and access authorization of software modules with these software components. For example, if a user uses the software module A three times, the software module B twice, and the software module C once, then he obtains from the software supplier a special authorization for the desired and requested supplied software in form of licenses that are matched to the order. This has the disadvantage that the license agreement has to be changed when the licenses are exchanged, and that the released licenses also need to be changed if the software is protected.

In addition to purchasing a license for using a software components, it is also possible to obtain a license for using software components by a leasing agreement (VDI News of Jan. 7, 2000). Leasing financing has the advantage that the liquidity of the Company is protected as compared to a direct purchase. The leasing rates are also balance-neutral. Disadvantageously, however, the leasing contract has to be changed if the demand for software components changes.

It has also been proposed in the application DE 19950249.8 to protect run-time software of an electronic device by providing functional components with value units. The approach described therein, however, is limited to run-time software, is implemented specifically for use of inflexibly defined functional components, and is inadequate to support applications in a distributed system.

It is therefore an object of the invention to provide a user of software modules with a simple, flexible method for licensing and/or access authorization of software modules, that can be adapted to changing requirements and employed particularly in distributed systems.

According to the invention, the object is solved in that a customer acquires value points as usage authorization for the desired software modules, wherein a valuation in the form of value points is associated with each software module, and that the customer is authorized if the number of the value points obtained by the customer reaches at least the sum of the value points of the actually desired software modules, wherein a license manager permanently computes and monitors the actual balance between the acquired and used value points.

The term software module will be used hereinafter synonymously with the term software program or software component.

The invention has the advantage that a customer does not sign a license agreement covering the used software modules and their quantity, but rather obtains a license agreement through value points. The customer can flexibly and usage-specific use the required software modules within the obtained “value point license”. A valuation in the form of value points instead of a price is associated with the software modules, wherein each value point has a price. Changes at the customer regarding the requirements or new software components do not require a change in the license agreement, if the valuation of the actually required software modules is covered by the already obtained value points. The use of value points as license currency for using software modules thereby significantly facilitates the management and license administration of software not only for the system, but also for an entire company. In particular, the invention simplifies the licensing process for software modules which are frequently changed or exchanged. Moreover, licensing according to the invention affords a high granularity and easy combination of the software modules. The invention also permits pre-ordering without specifying the functionality, i.e., a purchaser is not tied to specific software modules, but can obtain a number of value points and use the supply of points for any of the software modules.

By using value points as authorization currency for using software modules, the customer can make changes to his software requirements without changing the license agreement. This eliminates additional management and administration processes. The customer can, for example, obtain eight credit voucher for a number of value points and can flexibly hand over or exchange these value points for software modules. This allows the customer to individually assemble a software order without being obligated to accept preassembled packages from the supplier.

According to another advantageous embodiment of the invention, the customer can be authorized to use the actually desired software modules, when the number of the value points already acquired by the customer reaches at least the sum total of value points of the actually desired software modules. When using the software modules, there is no longer a verification required if an explicit license of the desired software module is present. Instead, the customer will be authorized to use the software by simply checking the total amount of the value points. By associating specific value points with each software module, the sum of the value points of the actually desired software modules can be easily compared with the value points obtained through the licensing agreement. The customer is authorized to use the software as long as the sum of the value points for the actually desired software modules does not exceed the value point account of the customer.

By having a license manager permanently monitor the actual number of required value points and comparing that number with the available value points, a customer account can be managed according to demand and usage. The license manager can easily integrate and consider the license implications of newly acquired value points, but can also easily recognize if additional value points are required in an application. The license manager determines permanently the “value point debit”, i.e., the sum of the value points of all actually required software modules, and compares that number with the “value point credit”, i.e., the total credit balance of value points acquired with the license.

According to a first advantageous embodiment of the invention, the license manager can be implemented as a mobile agent, which allows the licensing method to be easily employed in distributed environments. The software modules subject to a license can then be executed on devices that are connected, for example, by Fieldbus links, as well as by local area networks (LAN) or Internet and intranet links.

According to another advantageous embodiment of the invention, the value points required by the system for an application can be computed automatically. A user can thereby immediately recognize the licensing costs (in the form of value points) associated with a selected configuration of software modules or applications. The required number of value points can be determined by the license manager or, for example in industrial controllers, by a routine in the engineering system.

According to another advantageous embodiment of the invention, the value points can be transmitted via a data link or the Internet to the industrial controller/control system or to the computer systems. Accordingly, an additional data carrier or an additional hardware component is not required for transmitting the license currency (value points) to the customer.

According to yet another advantageous embodiment of the invention, the value points can be supplied on a data carrier which is already implemented for operating the controller or computer system. This facilitates handling at the controller and/or computer system and can also save both storage space and storage costs.

According to yet another advantageous embodiment of the invention, the value points can be supplied to the controller or computer system on a memory card. A memory card which can be inserted easily in a provided slot is typically routinely used with control devices.

According to another advantageous embodiment of the invention, the value points can be supplied to the control or computer system on a Multi-MediaCard (MMC) memory card which are suitable as information carriers due to their form and size. MMC memory cards have a similar look as the small SIM card used in cell phones.

Another advantageous embodiment of the invention provides that the value points for the entire system and/or an entire installation can be supplied at a single point and/or a single device or at different points and/or at different devices. This allows a customer to import license information (license currency of the form of value points) for software components relating to the entire system or installation in the same manner as for a single point, for example a single device. This makes it easier for a customer to handle licenses, in particular in distributed applications and network operations.

According to another advantageous embodiment of the invention, the required number and the actually available number of value points for the access authorization are compared when the software modules are installed. In other words, it is checked only at the time a customer of the software modules actually installs the acquired software modules on a device or a system, if the number of obtained value points is sufficient for the desired software modules. By debiting a value point account to the customer only when the software module is installed on a device or a system, the authorization of the customer for use of the software modules is checked only when the customer actually intends to use the modules. The value points are therefore entered into the accounting system only when actually required.

According to another advantageous embodiment of the invention, the required number and the actually available number of value points for the access authorization are compared only when the software modules are actually used. The value points can hence be associated with the number of manifestations and/or instantiations of the software modules. In this way, a customer can be provided with application-specific licensing methods for his explicit requirements. A customer who acquires a software module, for example a technology packet “positioning”, for motion control in an industrial controller, does not pay for the software with value points when he installs the technology packet, but rather only pays when a technology object of this technology packet “positioning” is actually used. The technology packet “positioning” can also include the technology object “positioning axis.” A customer is billed for the required number of manifestations and/or instances of the technology object “positioning axis” or additional technology objects, i.e., his value point account is debited for the number of the manifestations and/or instances of the technology objects. By authorizing specific instances at run-time, the value point account of a customer is only debited for those software modules which are actually needed and used for the applications. This provides a finely granulated accounting mechanism, so that a customer has to pay only for the required and actually used functionality.

An embodiment of the invention is illustrated in the drawing and will now be described. It is shown in:

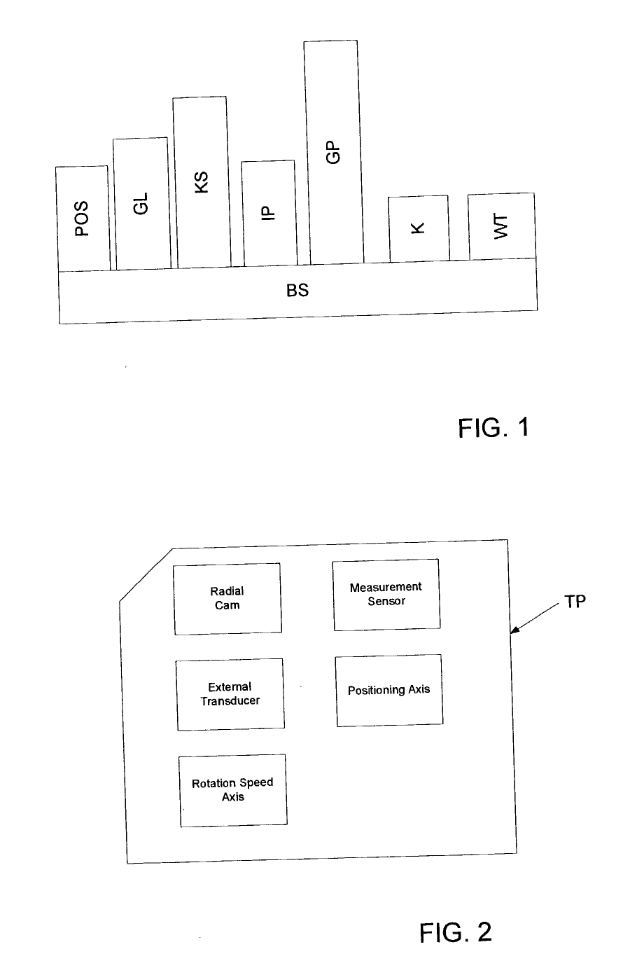

FIG. 1 a schematic diagram of software modules for motion control;

FIG. 2 schematically, a technology packet with technology objects for positioning;

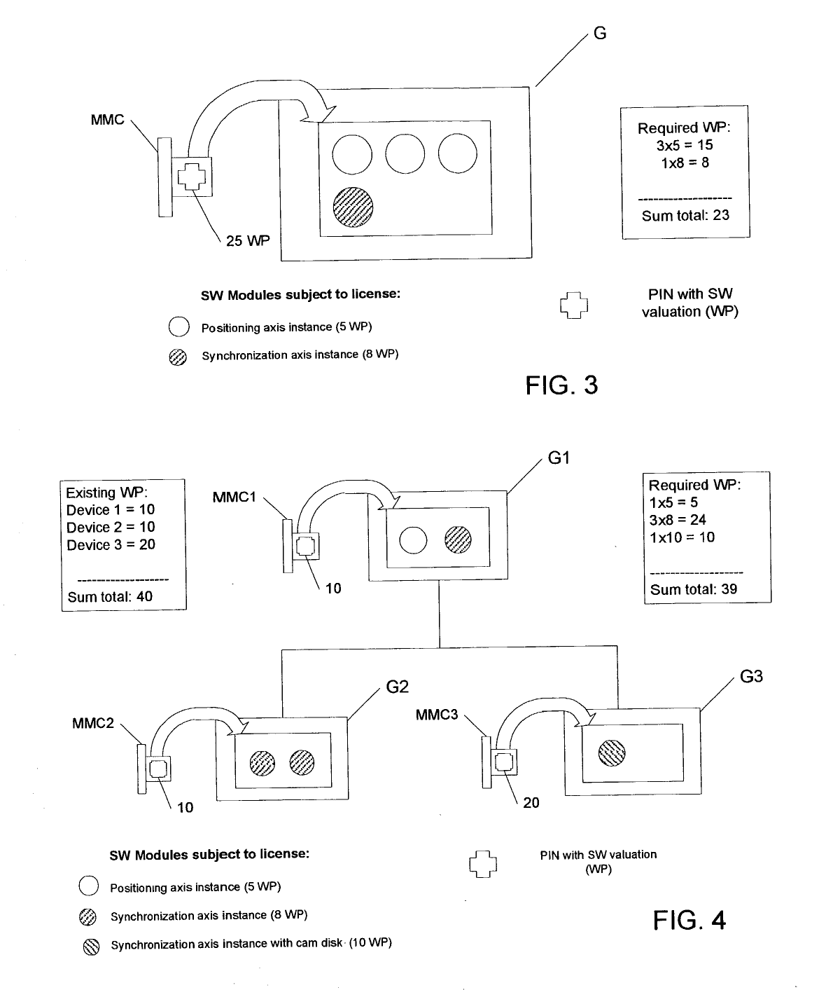

FIG. 3 a scenario for licensing and access authorization of software modules on a device by using value points;

FIG. 4 a scenario for licensing and access authorization of software modules for several networked devices by using value points;

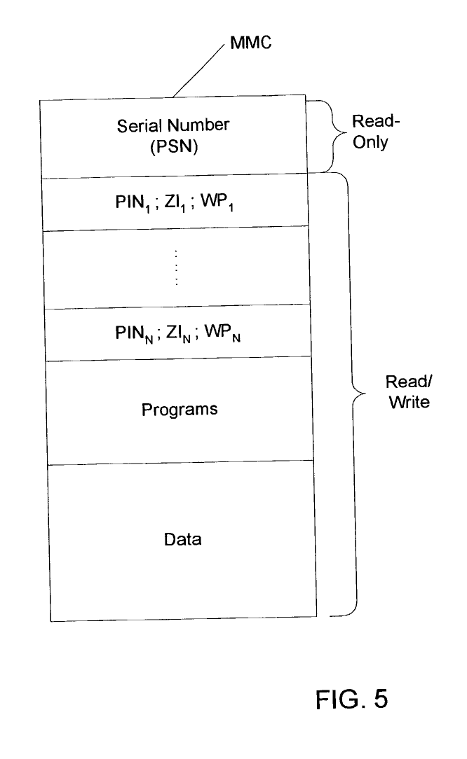

FIG. 5 the internal organization of a Multi-Media-Card (MMC) memory card; and

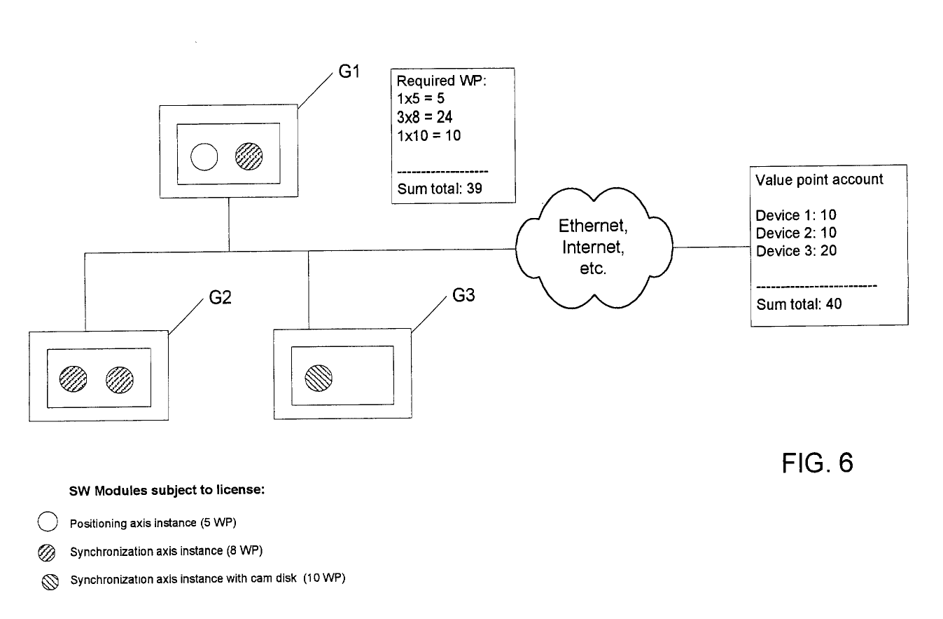

FIG. 6 schematically, a diagram of the connection between control devices and a server via an Ethernet or Internet link.

FIG. 1 shows exemplary software modules for a motion controller. A motion controller typically includes a basic system BS and software modules POS (Positioning), GL (Synchronization), KS (Radial Cam), IP (Interpolation), which a user can acquire to fit specific requirements and applications. The software modules represent technology packets for certain functionalities and can include additional technology objects. The software modules of the motion controller are indicated schematically in FIG. 1 by rectangles. In addition to the basic system BS, a user or purchaser can acquire software modules (POS) for positioning, (GL) for synchronization, (KS) for radial cam disks, and/or (IP) for interpolation. The user can also purchase a total package that includes Positioning, Synchronization, Radial Cams, and Interpolation in a single software module GP. In addition to the typical functionalities for motion control devices, a user or customer can also acquire software modules K (Plastic) or WT (Additional Technologies) for specific technologies. As indicated in FIG. 1, the software component K (plastic) can be acquired for motion control devices that are intended to be used specifically for machining plastic. As also indicated in FIG. 1, specific software components WT can be required for additional technologies. A valuation in the form of value points is associated with all the illustrated software modules. A user can flexibly use the desired software modules by staying within the number of the acquired value points (licensing). Accordingly, a user can scale the motion control device simply by using certain software modules and thereby customize the control tasks.

FIG. 2 shows schematically (beveled rectangle) an exemplary technology packet (TP) “Positioning”. The technology packet may include the following exemplary technology objects which are indicated as rectangles: Radial Cam, External Transducer, Rotation Speed Axis, Measurement Sensor and Positioning Axis. A user can use several manifestations or instances of these technology objects in a single application.

User authorization (i.e., a check if sufficient value points are available at the customer/user for the desired software module) can then be checked during installation, i.e., when the technology packets are loaded. Alternatively, the user authorization can be checked during use, i.e., when the technology objects are instantiated. For example, if 3 WP are associated with the technology object Rotation Speed Axis, then a user who wishes to use two instances of the technology object Rotation Speed Axis has to acquire 6 WP. This possibility of linking the licensing process to the actual use of the technology objects is flexible and transparent to the customer.

FIG. 3 depicts a scenario for licensing and access authorization of software modules on a single device using value points. Software modules subject to licenses, such as instances of technology objects (indicated as small circles), are to run on the device G (e.g., a motion controller). The device G is shown as a rectangle. An identification number PIN, which designates the software licenses, is assigned to the device on an integratable MMC-memory card MMC (indicated by open arrows) which includes the software valuation in the form of 25 value points (WP). The identification number PIN, which includes the software valuation in the form of value points, is indicated by a small cross. Instances to be executed on the device G are indicated by differently patterned small circles.

The software modules in FIG. 3 are interpreted as instantiations or instances of objects. A positioning axis instance is depicted by the open circle. A positioning instance is valued at five value points. The circle hatched from the lower left to the upper right depicts a synchronization axis instance. The synchronization axis instance is valued at eight value points. 3 positioning axis instances (each requiring 5 WP) and one synchronization instance (requires 8 WP) are to be executed on the device G.

25 value points (WP) exist on the device G which are introduced by the MMC memory card. Based on the actual configuration, however, only 23 value points are required. The field inside the box on the upper right side of FIG. 1 shows the required value points. The three positioning axis instances require 3×5 WP and the synchronization axis instance 8 WP, for a total of 23 WP. The user is therefore permitted to run the desired configuration (3 positioning axis instances and one synchronization axis instance) on the device G.

A license manager implemented in software continuously checks the nominal—actual balance of required and existing value points WP. The license manager can be integrated, for example, in the basic system BS of the controller (see FIG. 1).

FIG. 4 shows a scenario for licensing and access authorization of software modules for several networked devices using value points.

The illustrated system includes three networked devices G1, G2 and G3 shown as rectangles, with the network indicated by connecting lines. An identification number PIN containing the software valuation in the form of value points is assigned to each device G1-G3 on an integratable MMC memory card MMC1-MMC3 (indicated by open arrows). In the scenario depicted in FIG. 4, MMC1 includes ten, MMC2 also ten, and MMC3 twenty value points, associated with the corresponding devices G1-G3. Accordingly, the entire system contains forty value points.

In the field in the upper left corner of FIG. 4, the value points existing in the system are represented for each device as well as their sum total. The identification number PIN containing the software valuation in the form of value points is indicated by a small cross. The software modules to be executed on the devices G1-G3 are depicted by differently patterned small circles. The software modules in FIG. 4 are interpreted as instantiations or instances of object types. A positioning axis instance is illustrated by an open circle. The valuation of a positioning axis instance is five value points. A circle with a hatching from lower left to the upper right depicts a synchronization axis instance. The valuation of the synchronization axis instance is eight value points. The circle with a hatching from upper left to the lower right depicts a synchronization axis instance with a cam disk. The valuation of this software module is ten value points.

Each of the acquired value points (software valuation) is encrypted with an identification number PIN. The identification numbers PIN are entered into the system or the devices G1-G3 from the MMC memory cards MMC1-MMC3, where they are stored.

In the example of FIG. 4, the MMC1 memory card has ten value points, the MMC2 memory card has also ten value points, and to the MMC3 memory card has twenty value points. In the upper left field of the Figure, the value points existing in the system and/or the devices are illustrated, with a total of forty value points existing in the system. The existing value points WP can be viewed as credit, or as value point credit. In the illustrated example, a total of forty value points is available which are distributed over the three MMC memory cards MMC1-MMC3.

However, only 39 value points are required based on the actual configuration, because the device G1 requires one positioning axis instance, i.e., 5 WP, and one synchronization axis instance, i.e., 8 WP; the device G2 requires two positioning axis instances, i.e. 2×8 WP; and the device G3 one synchronization axis instance with radial cam disk, i.e. 10 WP. The field in the upper right in the Figure shows the number of value points required in the system, namely 39. The required value points represent the usage or the value point debit. Since a sufficient number of value points (forty) is available in the system, the configuration can be operated in this form and is fully licensed. The total number of value points in the system decides the access authorization.

The license manager permanently tracks the number of value points WP required by an application and compares that number with the number of value points WP existing for the entire system. If a deficiency of value points WP is detected, operation in the actual configuration is not permitted and/or enabled.

With respect to local devices, the number of the required value points WP can exceed the number of the existing value points WP. In the example depicted in FIG. 4, a synchronization axis instance and a positioning axis instance run on the device G2 requiring 16 value points. However, only 10 value points are stored on the local MMC memory card MMC1 for the device G2. This local value point deficit is compensated by the value points assigned to the remaining devices. Accordingly, even when no value points are assigned to individual devices, the software components assigned to the devices can still run properly and are properly licensed, if the sum total of the value points existing in the system is sufficient. Alternatively, all value points required for the system can be introduced on a single device.

FIG. 5 shows schematically the internal organization of an MMC memory card. The MMC memory card is organized into blocks, with the uppermost block of the card representing a Card Identification Block which is written by the manufacturer of the MMC memory card. The Card Identification Block includes a unique hardware identification PSN. This region can only be read (by the checking software), but cannot be copied. The subsequent blocks include the licenses value points WP1-WPn, additional information ZI1-ZIn (e.g., information in the event of different licensors), as well as identification numbers PIN1-PINn generated by an encryption algorithm (for different licensors). An MMC memory card can also contain programs and data.

All blocks of an MMC memory card, except for the block containing the unique hardware identification PSN and which is only readable, are both readable and writeable and can also be copied.

FIG. 6 illustrates a controller comprised of three networked devices G1, G2, and G3, with the device is indicated by rectangles and the network indicated by connecting lines. The controller can be connected with a server S, for example, via an Ethernet or in Internet connection. Value points can be transmitted to the controller and the devices G1-G3 via the Ethernet and/or Internet connection. The server S is indicated on the right-hand side of FIG. 6 by a rectangle.

The software modules (in FIG. 6 as exemplary instances of technology objects) to be executed on the devices G1-G3 are indicated by differently patterned small circles. The open circle indicates a positioning axis instance. The valuation of a positioning axis instance is five value points (5 WP). A synchronization axis instance is depicted by a circle with hatching from lower left to the upper right. The valuation of this synchronization axis instance is eight value points (8 WP). A synchronization axis instance with radial cam disk is indicated by a circle with hatching from the upper left to the lower right, having a valuation of ten value points (10 WP).

The server S transfers via the Ethernet or Internet connection forty WP to the devices G1-G3 of the controller. The value point account of the server S includes, for example, for the device G1 ten WP, for the device G2 also ten WP, and for the device G3 2 twenty WP. Accordingly, there are altogether 40 WP available to the controller.

However, based on the actual configuration, only thirty-nine value points are required, because the device G1 requires one positioning axis instance, i.e. 5 WP, and one synchronization axis instance, i.e. 8 WP; the device G2 requires two synchronization axis instances, i.e. 2×8 WP; and the device G3 requires one synchronization axis instance with radial cam disk, i.e. 10 WP. The boxed-in field in the center shows the number of value points required for the system, namely 39. The required licenses represent the usage or the value point debit. Since a sufficient number of licenses (forty) is available in the entire system, the operation in this configuration, which requires 39 value points, is permitted and properly licensed. Access authorization is decided based on the sum total of the value points in the system.

With respect to local devices, the number of the required value points can exceed the number of the existing value points. In the example depicted in FIG. 6, two synchronization axis instances run on the device G2 requiring 16 value points. However, only 10 value points are stored on the server S account for the device G2. This local value point deficit is compensated by the value points associated with the other devices. Accordingly, although no value points may be assigned to some individual devices, the software components assigned to these devices can still run properly under a license, if the sum total of the value points existing in the system is sufficient. Alternatively, all value points WP required for operating the controller can be associated with a single device of the controller.

In the scenario depicted in FIG. 6, a license manager implemented in software continuously checks the nominal—actual balance of the required and existing value points. In a distributed operation (distributed, for example, over a local area network or the Internet), the license manager can be implemented as a mobile agent.

1. Method for licensing and/or access authorization of software modules for industrial controllers and/or computer systems, characterized in that a customer acquires value points (WP, WP1-WPn) as usage authorization for the desired software modules, wherein a valuation in the form of value points (WP, WP1-WPn) is associated with each software module, and that the customer is authorized if the number of value points (WP, WP1-WPn) acquired by the costumer reaches at least the sum of the value points (WP, WP1-WPn) for the actually desired software modules, whereby the license manager continuously computes and monitors the actual balance between the acquired and used value points (WP, WP1-WPn).

2. Method for licensing and/or access authorization of software modules according to claim 1, characterized in that the license manager is implemented as a mobile agent.

3. Method for licensing and/or access authorization of software modules according to claim 1 or 2, characterized in that the system automatically computes the value points (WP, WP1-WPn) required for an application.

4. Method for licensing and/or access authorization of software modules according to claim 1, 2 or 3, characterized in that the value points (WP, WP1-WPn) are transmitted via a data line or via the Internet to the industrial controllers and/or computer systems.

5. Method for licensing and/or access authorization of software modules according to claim 1, 2 or 3, characterized in that the value points (WP, WP1-WPn) are supplied on a data carrier, which exists anyway to operate the controller or the computer system.

6. Method for licensing and/or access authorization of software modules according to claim 1, 2 or 3, characterized in that the value points (WP, WP1-WPn) are supplied to the controller or the computer system on a memory card.

7. Method for licensing and/or access authorization of software modules according to claim 1, 2 or 3, characterized in that the value points (WP, WP1-WPn) are supplied to the controller or the computer system on a multimedia card (MMC memory card, MMC1-MMC3).

8. Method for licensing and/or access authorization of software modules according to one of the preceding claims, characterized in that the value points (WP, WP1-WPn) are supplied for the entire system and/or an entire installation at a single location and/or device or at different locations and/or different devices.

9. Method for licensing and/or access authorization of software modules according to one of the preceding claims, characterized in that the comparison of the nominal-actual number of value points (WP, WP1-WPn) required for the access authorization is performed when the software modules are installed.

10. Method for licensing and/or access authorization of software modules according to one of the preceding claims, characterized in that the comparison of the nominal-actual number of value points (WP, WP1-WPn) required for the access authorization is performed when the software modules are used.
